(19) United States
(12) Patent Application Publication
(10) Pub. No.: US 2007/0089933 A1
(43) Pub. Date: Apr. 26, 2007

(54) Ladder leveler and method of use

(76) Inventor: Brian Davison, Kent (GB)

Correspondence Address: Galasso & Associates, LP, P.O. Box 26503, Austin, TX, 78755-0503, US

(21) Appl. No.: 11/255,693

(22) Filed: Oct. 21, 2005

(51) Int. Cl. E06C 7/00

(52) U.S. Cl. 182/200

(57) ABSTRACT

The ladder leveler is an extension that is capable of being attached to the leg of any ladder. A first metal extension and a second metal extension are used to form a box around the ladder leg. The first metal extension further comprises a non-threaded shaft sleeve, a threaded length adjusting shaft and a threaded nut. Once the first metal extension and the second metal extension are secured around the ladder leg. The length of the extension is adjusted by rotating the threaded length adjusting shaft until the desired length is reached. At that time the threaded length adjusting shaft is locked into place by tightening the thread nut. On the bottom of the threaded length adjusting shaft is a ball socket and an articulating base foot comprising a non-slip rubber coating.

### FIELD OF THE DISCLOSURE

Ladders and ladder leveler systems, devices and methods for leveling ladders on uneven surfaces

### BACKGROUND

Using a ladder is a common practice to most everyone. At some point everyone needs to reach something that is above their head. Sometimes, a simple task like hanging a picture can require a ladder. Painting is another example of when an individual might have a need for a ladder. Whatever the need, we all like to have a little security when climbing on a ladder. Part of that security comes from the fact that the ladder is level from the point of origin upward. However, there are a number of instances where this would not be the case. For example, if you are working outside, painting your house for example, it would be very rare for the ground to be exactly level. Another example would be if you were trying to paint a stairway, the steps are not deep enough to get both legs of the ladder on one level. Rather than buy one of the ladders that has four or five different sections that basically form into a scaffolding type configuration, it would be easier if you could actually level the current ladder that you have so that is it safe to climb. The other option for using a ladder in a non-level situation, depending on how unlevel the surface may be, is to have someone hold the ladder in an effort to help stabilize and balance it. While this typically works well if the person climbing on the ladder is handling a task that is straight up, it becomes a little more problematic if they are reaching out to the sides to perform a task. An example of when one would need to reach to perform a task would include when one is painting. Typically, one tries to accomplish as much as possible when on the ladder in an effort to reduce the number of trips up and down the ladder as well as the number of times that a ladder must be moved. While there is always a risk of a ladder falling when someone is on it, that risk is reduced when the ladder is level.

Working on a set of stairs is probably one of the toughest tasks that can be performed on a ladder. Often times, there is no place to brace the ladder or the angle in which you must brace the ladder leaves one leg hanging in the air. Obviously, one cannot climb a ladder with one leg not on a solid surface. For this type of circumstance, one must either own or borrow scaffolding or a ladder that conforms into somewhat of scaffolding type set up or is capable of being manipulated such that a stable climbing surface is provided. Alternatively, one would have to rent scaffolding and/or this type of ladder. This is not practical, particularly if it is a small task to be performed.

### SUMMARY OF THE DISCLOSURE

In one embodiment of the present invention, the ladder leveler comprises a first and second metal extension

In another embodiment the first and second metal extensions are operable to attach to each other.

In still another embodiment the ladder leveler comprises at least two bracket securing bolts.

In another embodiment the bracket securing bolts are located on the back of the first metal extension.

In yet another embodiment the first metal extension comprises a non-threaded shaft sleeve.

In still another embodiment the non-threaded shaft sleeves comprises a top and a bottom.

In another embodiment the first metal extension comprises a threaded nut.

In yet another embodiment the threaded nut is attached to the bottom of the non-threaded shaft.

In another embodiment first metal extension comprises a threaded length adjusting shaft.

In still another embodiment the threaded length adjusting shaft connects to the threaded nut.

In yet another embodiment the threaded nut operates to move the threaded length adjusting shaft into and out of the non-threaded shaft sleeve.

In still another embodiment the ladder leg extension comprises a ball socket.

In another embodiment the ball socket is attached to the threaded length adjusting shaft.

In yet another embodiment the ladder leg extension comprises a base foot.

In still another embodiment the base foot is attached to the ball socket.

In another embodiment the ladder leg extension comprises at least two bracket securing sleeves located on the second metal extension.

In still another embodiment the first and second metal extensions are operable to attach together.

In yet another embodiment the first and second metal extension attach together around the bottom leg of a ladder.

In another embodiment the first and second metal extensions rest against the lowest rung of a ladder when connected.

In still another embodiment the threaded nut rotates to lock the threaded length adjusting shaft to the non-threaded shaft sleeve.

In yet another embodiment the bracket securing bolts are slidable into said bracket securing sleeve.

In still another embodiment the first and second metal extensions form a box around the bottom leg of a ladder.

In another embodiment the ball socket operates to pivot the base foot.

In yet another embodiment the base foot comprises a non-slip rubber coating.

In still another embodiment the base foot is an articulating foot capable of swiveling 360 degrees.

In another embodiment the first and second metal extensions operate to level a ladder.

In yet another embodiment the threaded length adjusting shaft is a male component.

In still another embodiment the threaded length adjusting shaft operates to adjust between zero and 18 inches.

In another embodiment the non-threaded shaft sleeve is a female component.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 illustrates a front view of the ladder leveler.

FIG. 2 illustrates a rear view of the ladder leveler.

FIG. 3 illustrates a side view of the ladder leveler.

FIG. 4 illustrates a top view of the ladder leveler.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

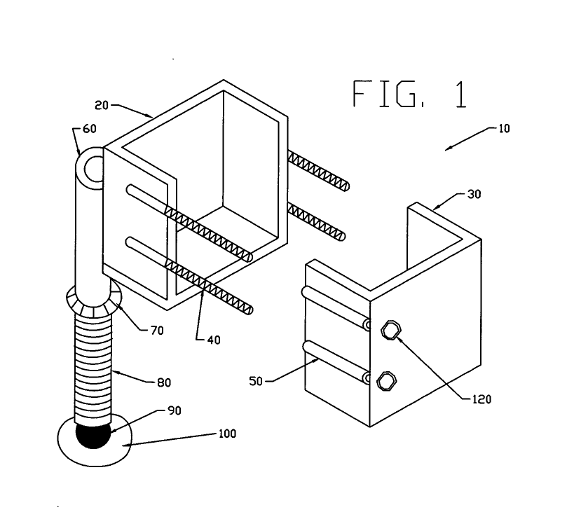

FIG. 1 depicts a ladder leg extension 10 comprising a first metal extension 20, a second metal extension 30, bracket securing bolts 40, bracket securing sleeves 50, a non-threaded shaft sleeve 60, a threaded nut 70, a threaded length adjusting shaft 80, a ball socket 90 a base foot 100 and a non-slip rubber coating 110.

The ladder leg extension 10 is designed to fit around the legs of a ladder for purposes of leveling a ladder on a un-even surface. The ladder leg extension 10 is designed to fit around each leg of a ladder. For example, if one wanted to use a ladder on a stairway, then the ladder leg extension 10 would be coupled to at least one leg of the ladder by using the first metal extension 20 and the second metal extension 30 to form a box around the leg of the ladder. By sliding the bracket securing bolts 40 into the bracket securing sleeves 50, the first metal extension 20 and the second metal extension 30 can be pushed together to form a tight fit to the ladder leg. Since the bracket securing bolts 40 are threaded, once they are inserted into the bracket securing sleeve 50, a hex nut 120 is screwed onto the bracket securing bolts 40. The hex nut 120 functions to secure the first metal extension 20 and the second metal extension 30 tightly around the ladder leg. Once the first metal extension 20 and the second metal extension 30 are attached to each ladder leg, the next step is to determine the height needed for each particular ladder leg. By rotating the threaded length adjusting shaft 80 upward into the non-threaded shaft sleeve 60 or downward out of the non-threaded shaft sleeve 60, the length required for each ladder leg can be determined. When the length is determined and the ladder is level, the threaded nut 70 is tightened to hold the threaded length adjusting shaft 80 in place.

The first metal extension 20 and the second metal extension 30 are designed so that when they are connected they form a box with the top open. The first metal extension 20 and the second metal extension 30 can be comprised of aluminum, similar to the type used for most ladders or alternatively, they could be comprised of a galvanized metal or hard plastic that is capable of withstanding the weight limit prescribed for the ladder itself.

The bracket securing bolts 40 are inserted into the bracket securing sleeve 50 and a hex nut is placed on the bracket securing bolts 40 creating a tight fit. The bracket securing bolts 40 cause the first metal extension 20 and the second metal extension 30 fit tight around the ladder leg, preventing the separation of the first metal extension 20 from the second metal extension 30. Therefore, once the first metal extension 20 and the second metal extension 30 are connected around the ladder leg, the ladder leg extension 10 will not fall off of the ladder leg when the ladder is moved from one place to another. While the bracket securing bolts 40 and bracket securing sleeves 50 are shown in this configuration, there are other alternatives for attaching the first metal extension 20 to the second metal extension 30. For example, any type of latching mechanism such as a sliding lock, a hook and eye type lock, a clasp or a loop latching mechanism similar to those used on most tool boxes could be used.

FIG. 1 further depicts a ball socket 90 which is attached to the threaded length adjusting shaft 90 and a base foot 100. The base foot 100 is an articulating foot that is capable of rotating 360 degrees. It is also equipped with a non-slip rubber coating 110 that prevents the base foot 100 from slipping thereby causing the ladder to fall.

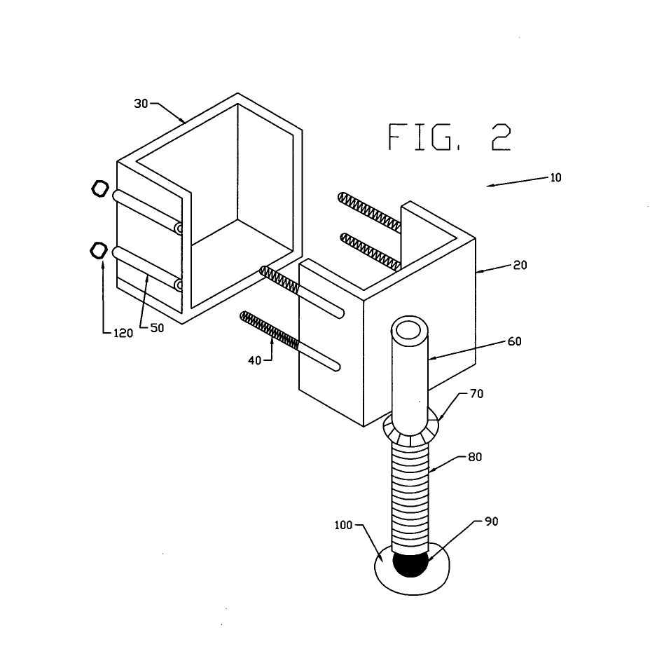

FIG. 2 is a back view of the ladder leg extension 10 showing the first metal extension 20, the second metal extension 30, including the bracket securing bolts 40 and the bracket securing sleeves 50. It further illustrates the non-threaded shaft sleeve 60, the threaded length adjusting shaft 80, the threaded nut 70, the ball socket 90 and the base foot. The non-threaded shaft sleeve 60 is adhered to the first metal extension 20. Depending on the type of material that is used for the construction of the ladder leg extension, would determine the method for adhering the non-threaded shaft sleeve 60 the first metal extension 20.

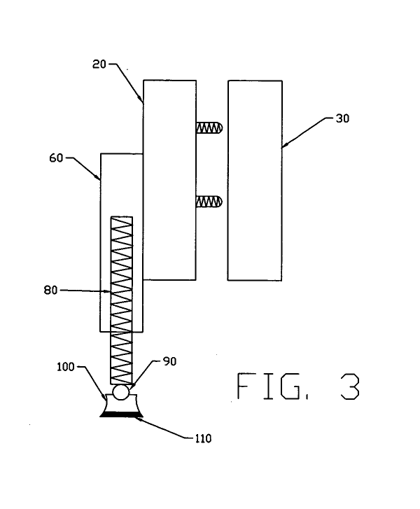

FIG. 3 is a side view of the ladder leg extension 10, showing the first metal extension 20, second metal extension 30, bracket securing bolts 40 and further depicts the threaded length adjusting shaft 80. FIG. 3 illustrates the threaded length adjusting shaft 80 when a portion of it is adjusted up into the non-threaded shaft sleeve 60. This allows the ladder leg extension 10 to extend only a minimal amount from the ladder leg. The ladder leg extension 10 is designed to allow for the extension of a ladder leg to a maximum of 18 inches. While it can extend a smaller amount the maximum extension would be 18 inches. Therefore, if one is working on a stairway, then the one leg would be capable of extending outward to reach the height of the step where the other ladder leg is resting.

Additionally, FIG. 3 depicts the non-slip rubber coating 110 which is part of the base foot 100. Since most ladders are equipped with a gripping device on the bottom of the legs, when the ladder leg extension 10 is attached to the ladder leg the gripping device is not only not touching but is in fact covered. Therefore, the non-slip rubber coating 110 attached to the base foot 100 prevents that particular leg of the ladder from slipping and causing the ladder to fall.

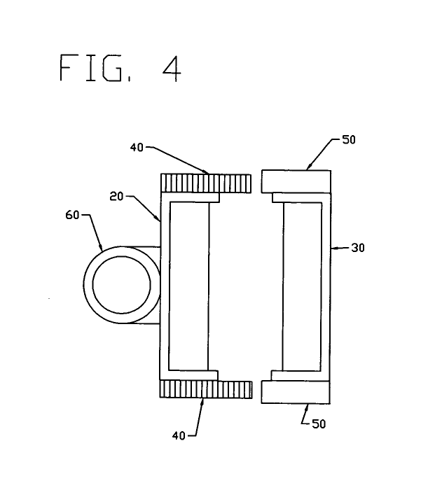

FIG. 4 illustrates a top view of the ladder leg extension 10 and further depicts a top view of the bracket securing bolts 40, the bracket securing sleeves 50 and the non-threaded shaft sleeve, as well as the first metal extension 20 and the second metal extension 30. FIG. 4 shows the non-threaded length adjusting shaft 60 attached to the first metal extension 20.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. A ladder leg extension comprising:
a first and second metal extension wherein said extensions are operable to attach to each other around the bottom leg of a ladder;
at least two bracket securing bolts located on the back of said first metal extension and wherein said first metal extension further comprises:
a non-threaded shaft sleeve having a top and a bottom;
a threaded nut attached to said bottom of said non-threaded shaft sleeve;
a threaded length adjusting shaft; wherein said shaft is attached to said threaded nut and operates to move said threaded length adjusting shaft into and out of said non-threaded shaft sleeve;
a ball socket; wherein said ball socket is attached to said treaded length adjusting shaft;
a base foot; wherein said base foot is attached to said ball socket; and
at least two bracket securing sleeves located on a back of said second metal extension; wherein said first and second metal extensions are operable to attach together around the bottom leg of the ladder and rests against a lowest rung of the ladder.

2. The ladder leg extension of claim 1, wherein said threaded nut rotates to lock the threaded length adjusting shaft to the non-threaded shaft sleeve.

3. The ladder leg extension of claim 1, wherein said bracket securing bolts are threaded.

4. The ladder leg extension of claim 1, wherein said bracket securing bolts are slidable into said bracket securing sleeves and operable to fasten together with a hex nut.

5. The ladder leg extension of claim 1, wherein said first and second metal extensions form a box around the bottom leg of the ladder.

6. The ladder leg extension of claim 1, wherein said ball socket operates to pivot said base foot.

7. The ladder leg extension of claim 1, wherein said base foot further comprises a non-slip rubber coating.

8. The ladder leg extension of claim 1, wherein said base foot is an articulating foot capable of swiveling 360 degrees.

9. The ladder leg extension of claim 1, wherein said first and second metal extensions function to level the ladder.

10. The ladder leg extension of claim 1, wherein said first and second metal extensions rests against the lower rung of the ladder.

11. The ladder leg extension of claim 1, wherein said threaded length adjusting shaft is a male component.

12. The ladder leg extension of claim 1, wherein said threaded length adjusting shaft operates to adjust between zero and 18 inches.

13. The ladder leg extension of claim 1, wherein said non-threaded shaft sleeve is a female component.

14. A ladder leveling system comprising:
a ladder having bottom side, a top side, a set of legs and a set of rungs with a lowest rung;
a set of first and second metal extension wherein said extensions are operable to attach to each other around said bottom side of said ladder legs;
at least two bracket securing bolts located on a back of said first metal extension and wherein said first metal extension further comprises:
a non-threaded shaft sleeve having a top and a bottom;
a threaded nut attached to said bottom of said non-threaded shaft sleeve;
a threaded length adjusting shaft; wherein said shaft is attached to said threaded nut and operates to move said threaded length adjusting shaft into and out of said non-threaded shaft sleeve;
a ball socket; wherein said ball socket is attached to said treaded length adjusting shaft; and
a base foot; wherein said base foot is attached to said ball socket; and
at least two bracket securing sleeves located on a back of said second metal extension; wherein said first and second metal extensions are operable to attach together around said leg of said ladder and rests against said lowest rung of said ladder.

15. The ladder leveling system of claim 14, wherein said base foot is articulating and capable of swiveling 360 degrees.

16. The ladder leveling system of claim 14, wherein said base foot further comprises a non-slip rubber coating.

17. The ladder leveling system of claim 14, wherein said threaded length adjusting shaft is capable of adjusting between zero and 18 inches.

18. A method for leveling a ladder comprising a first and second metal extension wherein said first metal extension comprises a non-threaded shaft sleeve having a top and a bottom, a threaded nut attached to the top; a threaded length adjusting shaft and at least two bracket securing bolts; and wherein said second metal extension comprises at least two bracket securing sleeves; said method comprising the steps of:
placing the first and second metal extensions around a lower leg of each side of the ladder so that the first and second metal extensions are against a lower rung of the ladder;
inserting the bracket securing bolts into the bracket securing sleeves, and attaching a hex nut to the bracket securing bolts creating a tight fit around said ladder leg;
placing the ladder in a desired location with the first and second metal extension located on the bottom; and
screwing the threaded nut causing the threaded length adjusting shaft to move in or out of the non-threaded shaft sleeve in order to move the ladder leg up or down causing the ladder to be level with the surface the where the ladder is standing.
